(19) United States
(12) Patent Application Publication
(10) Pub. No.: US 2004/0155897 A1
(43) Pub. Date: Aug. 12, 2004

(54) Printed user interface for electronic systems

(76) Inventors: Paul D. Schwartz, Boulder Creek, CA (US); Shin Saikyo, Sunnyvale, CA (US)

Correspondence Address: PATENT LAW OFFICES OF DAVID MILLERS, 6560 ASHFIELD COURT, SAN JOSE, CA, 95120, US

(21) Appl. No.: 10/364,218

(22) Filed: Feb. 10, 2003

(51) Int. Cl. G09G 5/00

(52) U.S. Cl. 345/716

(57) ABSTRACT

A user interface for a device such as a presentation player includes a sensor capable of sensing printed material. Commands for the device can thus be printed and sensed using the sensor, and the device does not require user interface hardware that is difficult to miniaturize. For a presentation player, the printed material can be a companion book or other printed material containing images or other printed sections that correspond to specific recorded audio or video sections. Sensing a symbol in or the content of a printed section indicates a data section that the player can select and play while the user views the corresponding printed section. The printed material can further include control signals to which the user applies the sensor to show authorization to use the system or to change the volume, tone, balance, time scale, brightness, contrast, color, or other operating parameter of the player.

### BACKGROUND

Electronic systems generally require user interfaces that permit activation and control of the functions of the systems. A computer, for example, normally has a relatively complicated user interface including hardware such as a keyboard, a mouse, a display, speakers, and an operating system that interprets a user's input commands and generates appropriate feedback. Such user interfaces are often a limiting factor that controls the minimum physical size and cost of the electronic systems. For example, keyboards or keypads having keys with separations much smaller than a human finger are difficult to operate, and electronic systems with keyboards or keypads cannot be reduced to a size smaller than the required size for the keyboard or keypad.

Alternative interfaces have thus been developed for miniaturized devices. Personal digital assistants (PDAs), for example, are often smaller than the smallest convenient keyboard size and employ touch screens with character recognition software to recognize hand written alphanumeric input. Although touch screen interfaces can be made smaller than keyboards, such interface hardware has a minimum size that depends on the user's ability to see objects on the screen and touch or write on the screen.

Voice recognition technology provides a user interface that is virtually free of size limitations based on the user's physiology. For interface hardware, a voice recognition system can use a microphone and associated electronic components, which can be very successfully miniaturized without sacrificing ease of use. However, dependable voice recognition technology currently requires more processing power than is now available in a small inexpensive device. Voice recognition technology is also more difficult to implement for operation with concurrent audio output.

A presentation player with time scaling audio and video capabilities is an example of an electronic system that normally requires a relatively complex user interface to provide all of the desired functional controls. Such presentation players generally play presentations that may be downloaded into memory or prerecorded on media such as a compact disk or DVD. Some desirable control functions for a presentation player include the ability to select a presentation from a set of recorded presentations, jump to any desired location in the recorded presentation, start the presentation at the selected location, and control audio and video properties such as the volume, tone, brightness and time-scale of the presentation being played. Implementing all of the control functions generally requires a tradeoff between ease of use and cost and/or size of the interface hardware. In particular, a convenient and intuitive user interface will generally require a relatively larger number of buttons for the user's input and/or some a touch screen to display the available selections and receive the user instructions.

Another issue for presentation players is the desirability of multimedia content. In particular, an audio or video presentation whether for entertainment or education can and often is enhanced through the addition of visual or explanatory material. However, a presentation player with audio, video, and graphical user interface display capabilities will generally be significantly more complex and expensive than presentation player having only audio and/or video playback capabilities. Storage of visual or explanatory material may also be a concern if the media used to record the presentation has a limited storage capacity.

A book or other printed material can support a recorded audio and/or video presentation, but the user must then match the sections of the printed material with the portion of the presentation being played. The distraction of identifying the correct printed images or text that correspond to a particular passage can make learning more difficult during an informative presentation and can make an entertaining presentation less enjoyable.

In view of the current state of the art, a user interface that is inexpensive, easily miniaturized, easy to use, and that can be supported with printed material is sought.

### SUMMARY

In accordance with an aspect of the invention, an electronic system such as a presentation player has a user interface including a sensor that is usable with printed material containing control information. Sensing the control information can activate a desired function of the electronic system. For a presentation player, accompanying printed material for the player may include control symbols for functions including selecting a presentation, selecting a location in a presentation, starting or stopping the presentation, and changing presentation characteristics such as the volume, tone, balance or time scale of the presentation. Accordingly, through a single sensor that may be easily miniaturized, a user interface can implement complex and detailed control functions that are customizable for each presentation.

In accordance with another aspect of the invention, printed material may provide information that the electronic system requires before granting access to particular functions. Accordingly, a user would require a specific printed key to unlock and use the protected system functions. Such printed information can include user identification, passwords or other security information, priority or authorization codes, expiration dates, and similar that may be required or useful for marketing, administrative, and security purposes.

In alternative embodiments of the invention, the sensor can be an imaging device such as camera or a scanning device capable of sensing printed control symbols. The control symbols can be sensed optically using light inside or outside the visible spectrum or magnetically using special inks. The printed symbols can take any form but preferably have forms that are easily distinguished using software requiring minimal processing power. The control symbols, for example, can be one-dimensional or two-dimensional barcodes, alphanumeric characters, other printed shapes or symbols, or images containing embedded or encoded information.

For a presentation player, the printed material can include text or images that accompanies the specific portions of the presentations. Each image can have control symbols or images that identify a corresponding location in the presentation. These control symbols or images can be embedded in the corresponding images (e.g., as watermarks) or can be separate code blocks adjacent to the images. Alternatively, the presentation player can recognize the images themselves and control play of the presentation according to the images being viewed. A user can quickly jump to the presentation section corresponding to an image or other printed material simply by applying the sensor to the image or associated control block. Thus, as a further aspect of the invention, a presentation player can automatically synchronize electronic portions of a presentation with the printed portions of the presentation without requiring the user to determine or know a reference for the printed content.

One specific embodiment of the invention is an electronic system including a sensor, a recognition unit, and a control unit. The sensor, which may be an imaging device or a scanner, is capable of sensing the printing in printed material. The recognition unit analyzes a signal from the sensor to identify a command represented by the printing, and the control unit directs the system to implement the command recognized by the recognition unit.

In a system such as a presentation player having an audio output system, implementing the command can change a characteristic such as the volume, tone, balance, or time scale of audio output from the audio output system. In the system has a video output system, implementing the command can change video characteristics such as brightness, contrast, and image size. Further, data for the presentation player may include multiple sections of a presentation, and implementing the command may change which of the sections is selected for playing. In accordance with another aspect of the invention, implementing the command can change a content characteristic such as the language of a presentation. For example, a presentation might be in English as well as French, German, Japanese. This allows for one presentation to be useful in multiple language presentations and foreign language education.

Another specific embodiment of the invention is a presentation that includes recorded media such as a compact disk or memory card with companion printed material. The recorded media stores one or more presentations formatted for a player. The printed material includes printed symbols that the player is capable of reading, and the symbols indicate information that the player can use when playing a presentation from the media.

The recorded audio or video on the media is generally divided into sections, and the printed material is similarly divided into printed sections. The printed sections respectively correspond to the audio/video sections, and each printed section contains content that the player is capable of reading to identify the printed section. Some examples of the content that the player is capable of reading in each printed section include a printed symbol, a watermark, or features of an image in the printed section. In addition to the printed sections that correspond to the recorded sections, the printed material can further include printed symbols indicating the functions that the player capable of performing, where sensing these printed symbols activates the respective functions. Some of the functions that can be activated this way include setting a volume, tone, balance, or time scale of audio output from the player.

Another specific embodiment of the invention uses printed material to navigate files in an electronic system such as a presentation player. In this embodiment, a printed index of files stored in the system or player would contain symbols, barcodes, or images with embedded data that allow the user to select a desired file. In a music system such as an MP3 player or a system capable of playing video files such as DivX files, a media content management application that load files to the player could also print a file list containing coded information for file selection.

Yet another specific embodiment of the invention is a method for operating an electronic system such as a presentation player. The method includes applying a sensor in a player to printed material, analyzing the output of the sensor to identify printed content of the printed material; and operating the player in accordance with the printed content of the printed material. The printed content can identify a target section from among the sections in the player or identify an operating parameter or mode of the player. Operating the player in accordance with the printed content then includes selecting the target audio section or setting the operating parameters or mode of the players.

### BRIEF DESCRIPTION OF THE DRAWINGS

FIG. 1 is a block diagram of an electronic system in accordance with an embodiment of the invention.

FIG. 2 illustrates a presentation in accordance with an embodiment of the invention that include media containing recorded data and companion printed material.

FIG. 3 is a flow diagram for a process of using a presentation system with printed material in accordance with an embodiment of the invention.

FIG. 4 illustrates an embodiment of the invention in which a music player employs a printed interface for song selection.

FIG. 5 illustrates an embodiment of the invention in which the tuning of a television is selected according through optical sensing of a television guide.

Use of the same reference symbols in different figures indicates similar or identical items.

### DETAILED DESCRIPTION

In accordance with an aspect of the invention, an electronic system has a user interface that includes a printed material and a sensor capable of sensing printing, or printed images. The sensor can replace conventional interface hardware such as a keypad or keyboard and still permit a user to easily input complex commands or control instructions to the electronic system. The sensor can be implemented using conventional scanning or imaging technology and can be miniaturized for small inexpensive electronic devices. The printed material for the electronic system can include control symbols for activation of the various functions of the electronic system and symbols identifying text, images, or other visual content of the printed material. The electronic system can thus synchronize its operation with the visual content that a user is viewing.

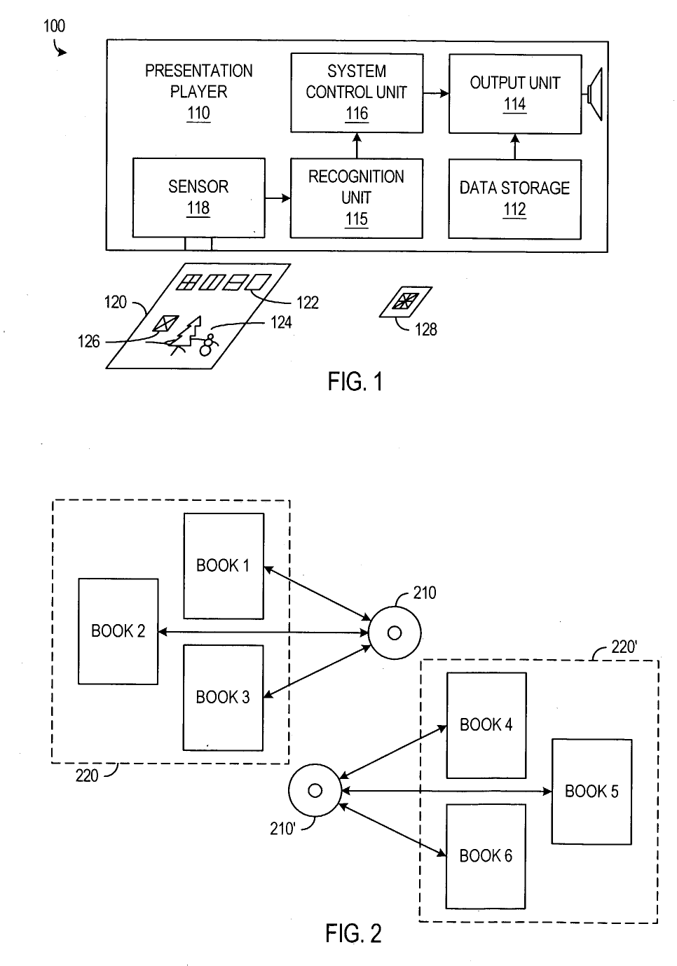

One electronic system that employs a user interface in accordance with the present invention is a player of recorded audio or video. FIG. 1 is a block diagram of a player system 100 in accordance with an embodiment of the invention. System 100 includes an electronic system (or player) 110 and printed material 120.

Player 110 includes data storage 112, which can be any type of storage capable of storing information for electronic presentation. Data storage 112 can include, for example, a removable and replaceable data storage media such as a DVD, CD, minidisk, a memory card, or memory stick containing prerecorded presentation data. Alternatively, data storage 112 can be a memory device such as a hard disk, Flash memory, or other volatile or non-volatile memory or buffer to which presentation data can be download via an interface (not shown). An output unit 114, which is under the control of a system control unit 116, receives data derived from the content of data storage 112 and provides electronic output. In illustrated embodiment of FIG. 1, audio output is illustrated as an example, but other electronic output such as video can also be provided.

System control unit 116 is a processor such as a microprocessor or microcontroller that executes software or firmware to control the functions of presentation player 110. The system functions generally include selection of data accessed from data storage 112, decoding of the accessed data for output unit 112, selecting a time scale or performing time scaling operation on an audio portion of the presentation, and providing operating parameters to data storage 112 and output unit 114. System control unit 116 receives user instructions through a sensor 118.

Sensor 118 can be any type of sensor capable or sensing at least some of the content 122, 124, and 126 of printed material 120. Many techniques for sensing the content of printed material are known. One class of sensor senses or measures the light reflected from the printed material, and the light can either be from a light source in sensor 118 or from the surroundings of printed material 120. Alternatively, special inks having a magnetic or other detectable properties can be used for some of content 122, 124, and 126, and sensor 118 is able to detect the properties and pattern of the special ink.

One well-known technique for sensing the content of printed material is scanning, which is commonly used to identify barcodes. Scanning generally detects a linear or a one-dimensional printed pattern and generates an electronic signal or a linear data stream that can be easily interpreted or decoded. In an embodiment of the invention using scanning, sensor 118 can be a light pen that a user runs across content 122, 124, or 126 of printed material 120 to input information or a command to presentation player 110. Other scanning devises such as scan guns are also well known and could be employed.

Another well-known technique for sensing the content of printed material is imaging. Imaging senses a two-dimensional pattern of the printing, and the two-dimensional pattern can be analyzed digitally or otherwise to identify the content of the image. For imaging, sensor 118 can be a camera containing a charge-coupled device (CCD) or CMOS optical sensor array that generates an array of pixel data. Well-known pattern and/or color recognition techniques can then identify specific printed items represented in the pixel array.

Recognition unit 115 interprets the electronic signal (e.g., a pixel array or scanned data) from sensor 118, identifies specific printed items, and provides information or control data to system control unit 116. In alternative embodiments, recognition unit 115 is software/firmware executed by system control unit 116 or a separate processing unit connected to system control unit 116. The specific recognition analysis that recognition unit 115 performs generally depend on the type of sensor 118 and the type of content 122, 124, or 126 being analyzed.

Printed material 120 can be any type of printed material including but not limited to one or more unbound page or one or more pages from a booklet, magazine, or book. For the purpose of illustration, the content of printed material 120 in FIG. 1 includes control symbols 122 for controlling the functions of presentation player 110, visual content 124 for the user, and identifying symbols 126 that identify visual content 124 to presentation player 110. Some of the content 122, 124, and 126 may not be required on the same page. For example, control symbols 122 may be separated on a control page or the inside or outside cover of a booklet, while visual content 124 with or without identifying symbols 126 fill the remaining pages of the booklet.

Control symbols 122 can be as varied as the functions of presentation player 110. Control symbols 122 may include: start/stop symbols; mode select symbols; volume up, down, and or level symbols; time scale up, down, or level symbols; and reference or status symbols. Additionally, control symbols 122 may indicate navigation information for directing the presentation player to a specific location. Generally, each control symbol 122 will have some user recognizable feature and a device recognizable feature. The various control symbols 122 can, for example, be captioned with text or universal signs that indicate the functions of the various control symbols 122. Alternatively, the user-recognizable feature and the sensor recognizable feature can be the same. Furthermore, the control symbol might be text data that is translated using well know Optical Character Recognition (OCR) techniques. In particular, the symbol 122 that sensor 118 senses can itself can be the universal sign that identifies the function corresponding to the that control symbol 122. The user uses the user recognizable features to identify a specific control symbol 122 corresponding to a desired function and then applies sensor 118 to the corresponding device recognizable feature to activate that function.

Control symbols 122 can be of any desired design. Each control symbol 122 can be a barcode, an alphanumeric character or combination of such characters as in printed text, a geometric shape or combination of geometric shapes, or a color-coded region, just to name a few examples. Control symbols 122 are preferably of designs that are relatively easy to quickly distinguish from each other using a minimal amount of processing power.

Visual content 124 presents to the user visible content of a presentation. In particular, while presentation player 110 is playing an audio presentation, visual content 124 in printed material 120 provides the images and/or text that correspond to the audio presentation. Each identifying symbol 126 corresponds to specific visual content 124 and provides a mechanism for indicating to presentation player 110 the identity of visual content 124. In one embodiment of the invention, the user applies sensor 118 to an identifying symbol 126 to synchronize the electronic portion of the presentation that presentation player 110 is playing to the visual content 124 that the user is viewing.

Identifying symbols 126 can be separate and visually distinct symbols to which the user applies sensor 118 to identify visual content 124. However, identifying symbols 126 generally do not need to be visible to the user. Identifying symbols 126 can take the form of watermarks (e.g. printed with information encoded in the images) or printed material that is not normally visible to the user (e.g., printed with ink that is visible only under ultraviolet light.) An invisible identifying symbol 126 would avoid or aesthetic problems or distractions that the identifying symbols 126 might otherwise present. A user then would apply sensor visual content 124 or a specific area relative to visual content 124 (e.g., upper right corner, above, or below), and sensor 118 would sense the symbol that is invisible to the user. In yet another alternative, identifying symbols 126 may be omitted when sensor 118 and recognition unit 115 directly identify visual content 124 for example by comparing an image or a scan of visual content 124 to prerecorded indexing data from data storage 112.

System 100 further includes authorizing material 128 representing information required before electronic system 100 grants access to particular functions. A user can thus apply sensor 118 to authorizing material 128 to enable use of system 100. Authorizing material 128 is illustrated in FIG. 1 as a separate printed key, but alternatively authorizing material 128 can be included among the control symbols 122 or with visual content 124 of printed material 120. Authorizing material 128 generally can convey information including a user identity, passwords or other security codes, priority or authorization codes, expiration dates, and similar information that may be required or useful for marketing, administrative, and security purposes. For example, a presentation player may provide access to copyrighted recorded material only if authorizing material 128 indicates the user has an authorization that has not expired, or system 100 may record information read from material 128 for subsequent charging of fees to an identified user's account.

FIG. 2 illustrates the combination of a media 210 containing one or more recorded presentations and a set of one or more companion books 220. Media 210 is for insertion in a presentation player (e.g., as part of data storage 112 of system 110) and can be implemented as a CD, DVD, memory card, or other removable or non-removable digital storage. Media 210 contains one or more recorded presentations that are divided into sections and indexed according to corresponding printed content in companion books 220. Media 210 may further include auxiliary data that a presentation player uses in a recognition process that is part of the user interface of the presentation player. For example, media 210 may contain data indicating visual clues that identify a particular command to the presentation player or a particular portion in the companion books.

Books 220, which may be pamphlets, magazines, or any other printed material, contain images or other printed material associated with the presentations record on media 210. This printed material is organized into sections (e.g., a set of one or more images) corresponding to the recorded audio or video sections on media, and each printed section is identifiable either from an associated identification symbol or symbols or from the content of the printed section. Books 220 may further include printed control symbols to which a user can apply the sensor of presentation player. Accordingly, the sensor in the presentation player can replace or reduce the complexity of other user interface hardware and still permit input of complex commands.

FIG. 2 also illustrates that different recorded media 210 and 210′ corresponding to different printed material 220 and 220′ can be used with the same presentation player. Printed material 220 and 220′ is customizable for recorded media 210 and 210′.

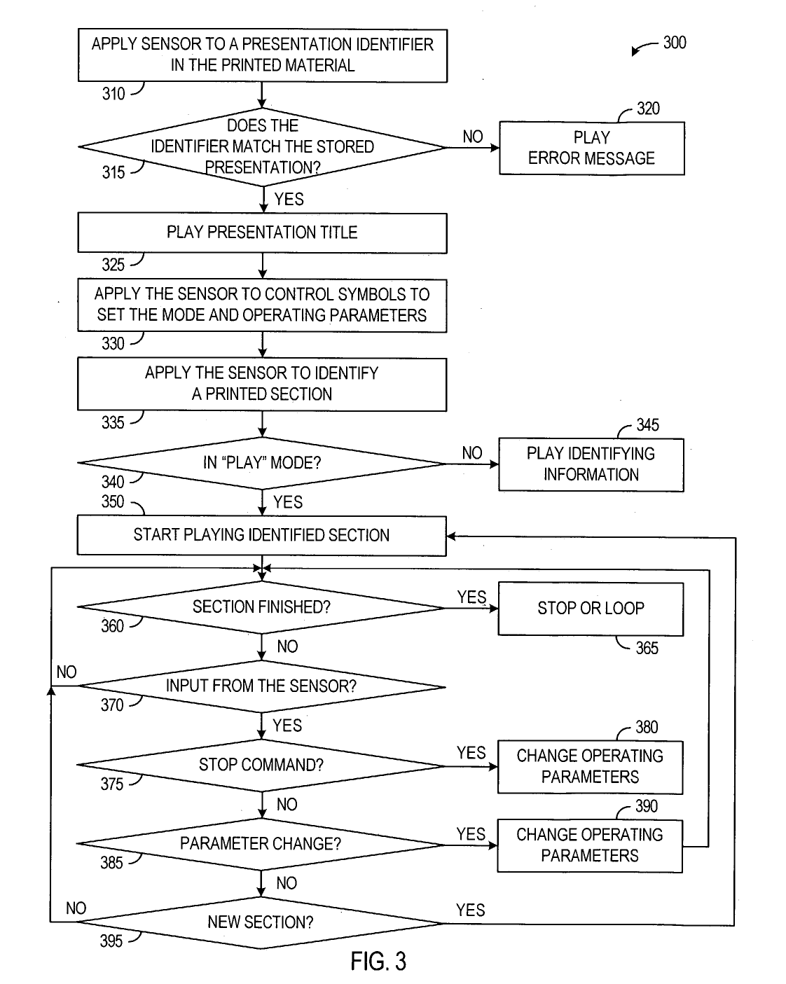

FIG. 3 is a flow diagram illustrating a process 300 for using system 100. Initially a user loads the presentation player with presentation data, for example, by inserting a disk or memory card into a drive or reader or by downloading the presentation into the player. The user in a step 310 then applies the sensor of the player to a presentation identifier symbol on a companion book for the presentation. The player in step 315 then determines whether the presentation identifier matches one of the presentations loaded into the player. The player can indicate that the presentation is ready (e.g., by playing the presentation title as in step 325) if the presentation corresponding to the identifier is available or play an error message (step 320) if the correct presentation is not in the player.

The user can also apply the sensor to control symbols as in step 330 to set the operational mode or operating parameters of the player. Some settings that may be controlled in this manner include: a command or play mode; an authorized or unauthorized user mode; the volume, tone, or balance of audio; the brightness, contrast, and color of video; and a time scale for the audio and video. Time scaling is a known process that can speed up or slow down the play rate of presentation without altering the pitch of the audio. Time scaling thus avoids unnatural sounding audio while allowing a user to play an informative presentation at a rate that matches the user's ability to absorb the information.

Once the user has loaded into the presentation player a presentation corresponding to printed material, the user can apply the sensor on the player to identify a section in the printed material as in step 335. In response, depending on the mode as determined in step 340, the player can play identifying information for the section as in step 345 if the player is in a command mode or start playing the identified audio section as in step 350 if the player is in a play mode.

After the player starts playing the selected selection, the player waits for the end of the section and monitors the sensor input to detect user commands. When the player in step 360 determines the end of a section has been reached the player in step 365 can either stop playing or loop back to start the selected section again depending on the operating mode.

If the player in step 370 senses a user command while playing, the player identifies the command and performs the appropriate action. For example, if the player in step 375 identifies sensing of a stop symbol, the player stops playing in step 380. If the player in step 385 identifies a command changing an operation parameter such as the volume, tone, balance, or time scale of the audio presentation, the player in step 390 changes the operating parameter so that characteristics of the audio changes. If the player in step 395 detects that the user applied the sensor to a new printed section, the player jumps to and starts playing the electronic section corresponding to the printed section.

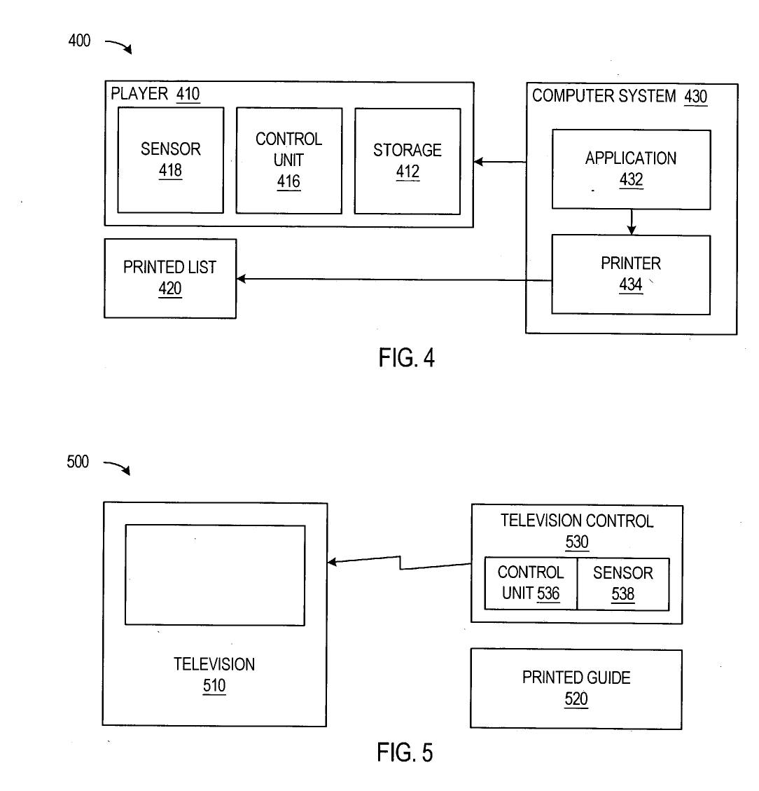

FIG. 4 illustrates an embodiment of the invention in which a system 400 includes a player 410 such as an MP3 player that can store a large number of songs as MP3 files or in other formats or a video player that can store a large number of video clips in DivX or other formats. The user typically downloads the songs or other files to data storage 412 in player 410 using a computer system 430. The content of player 410 is thus unique for each user, and providing a conventional user interface with easy navigation among a large number of files, for example, to select the user's desired song can be difficult. In system 400, player 410 has a user interface including a sensor 418 capable of sensing the printing on a printed file list 420. A control unit 416 analyzes a signal from sensor 418 to select a target file from among the files stored in data storage 412.

Printed list 420 lists the files (e.g., songs) in storage 412 and contains symbols that player 410 can read to distinguish the files. Printed list 420 can, for example, indicate that titles of songs with addresses indicating where respective songs are stored in data storage 412. An application 432, which can be used to control downloading of files to data storage 412, can control a printer 434, which is part of computer system 430, to print out list 420. The user can thus update list 420 whenever the user changes the content of data storage 412.

FIG. 5 illustrates another embodiment of invention in which as system 500 uses a printed television guide 520 to control a television 510. In system 500, a television control device 530 (e.g., a remote control) contains a sensor 538 and a control unit 536 capable of sensing and deciphering the content of printed television guide 520. For example, printed guide 520 can contain special control symbols for sensor 538, or control unit 536 may execute character recognition routines capable of reading text. A user reading the television guide can apply sensor 538 to a portion of printed guide 520 corresponding to a target program and activate control 530 to have television 510 select a channel or set reminder corresponding to the target program.

Although the invention has been described with reference to particular embodiments, the description is only an example of the invention's application and should not be taken as a limitation. For example, although the above describes user interfaces employed in a presentation player, such user interface can be employed other electronic systems where reduction in the size or cost of interface hardware is desired. Further, although the above description notes embodiments of the invention where printed material is the companion to recorded audio or video presentations, the audio or video is also a companion to the printed material. A book, magazine, or other printed document in accordance with the present invention may incorporate device readable information that identifies specific mood music or other companion output that a player can provide to augment the printed material. Various other adaptations and combinations of features of the embodiments disclosed are within the scope of the invention as defined by the following claims.

What is claimed is:

1. A presentation system comprising:
an output device capable of playing presentations;
a sensor capable of sensing printing on printed material;
a recognition unit connected to the sensor, the recognition unit analyzing a signal from the sensor to identify a command; and
a control unit connected to receive from the recognition unit a command for control of the output device playing of the presentations.

2. The system of claim 1, wherein the output device provides audio output, and the command controls a characteristic of the audio output from the output device.

3. The system of claim 2, wherein the characteristic is selected from the group consisting of volume, tone, and balance.

4. The system of claim 1, wherein the output device provides video output, and the command controls a characteristic is a property of video output from the output device.

5. The system of claim 4, wherein the command controls a source of video that the output device plays.

6. The system of claim 1, wherein the output device comprises a tuner, and the command selects a station to which the tuner is tuned.

7. The system of claim 1, wherein the command controls a time scale of a presentation.

8. The system of claim 1, wherein the system further comprises a data storage that stores multiple sections of presentation data, and wherein the command selects one of the sections.

9. The system of claim 8, wherein each section comprises an MP3 file.

10. The system of claim 8, wherein each of the section of presentation data comprises a section of audio data.

11. The system of claim 8, wherein the sections respectively correspond to songs, and the command selects one of the songs for the system to play.

12. The system of claim 11, further comprising application that when executed prints a list of the songs, the list being readable by the sensor, wherein applying the sensor to the list allows a user to select and play one or more songs from the list.

13. The system of claim 1, wherein the command enables access to selected functions of the system in response to the signal from the sensor providing required authorizing information.

14. The system of claim 13, wherein the authorizing information comprises information selected from the group consisting of a user identity, a password, a security code, a priority code, an authorization code, and an expiration date.

15. The system of claim 1, wherein the sensor comprises an imaging device.

16. The system of claim 1, wherein the sensor comprises a scanner.

17. A presentation comprising:
a media containing a presentation formatted for a player; and
printed material including printing that the player is capable of reading, the printing indicating information that is usable by the player when playing the presentation from the media.

18. The presentation of claim 17, wherein the media comprises a disk containing data representing the presentation.

19. The presentation of claim 17, wherein:
the presentation on the media is divided into data sections;
the printed material is divided into printed sections, wherein the printed sections respectively correspond to the data sections, and each printed section contains content that the player is capable of reading to identify the data section corresponding to the printed section.

20. The presentation of claim 19, in each printed section, the content that the player is capable of reading comprises a printed symbol.

21. The presentation of claim 19, in each printed section, the content that the player is capable of reading comprises a watermark.

22. The presentation of claim 19, in each printed section, the content that the player is capable of reading comprises features of an image in the printed section.

23. The presentation of claim 17, wherein the printed material further includes a plurality of printed symbols that the player is capable of reading, each symbol indicating a function that the player capable of performing.

24. The presentation of claim 23, wherein the functions indicated by the printed symbols comprise setting a characteristic of audio output from the player.

25. The presentation of claim 23, wherein the functions indicated by the printed symbols comprise setting a time scale of audio output from the player.

26. A method comprising:
applying a sensor in a player to printed material;
analyzing output of the sensor to identify content of the printed material; and
operating the player in accordance with the content of the printed material as determined by analyzing the output of the sensor.

27. The method of claim 26, wherein the content identifies a target sections from among a plurality of data sections stored in the player, and operating the player comprises selecting the target section.

28. The method of claim 26, wherein the content identifies an operating parameter of the player, and operating the player comprises setting the operating parameter.

29. The method of claim 28, wherein the operating parameter is selected from the group consisting of volume, tone, and balance of audio output from the player.

30. The method of claim 28, wherein the operating parameter is a time scale for a presentation.

31. The method of claim 26, wherein the content indicates whether a user is authorized to access a presentation that the player can otherwise play.

32. A system comprising:
a player comprising a sensor capable of sensing printed material and a storage device storing presentations; and
an application capable of identifying the presentations stored in the player and controlling a printer to print a list of the presentations stored in the player, wherein the player is capable of reading the list through operation of the sensor.

33. The system of claim 32, wherein the presentations represent songs downloaded into the storage device.

34. The system of claim 33, wherein the application further controls downloading of the songs into the storage device.

35. A system comprising:
a television;
a television control containing a sensor capable of sensing printed material; and
a printed television guide containing symbols that the television control is capable of sensing, wherein activation of the television control when the sensor is applied to an entry for a program causes the television to select the program.

36. The system of claim 35, wherein activation of the television control when the sensor is applied to the entry for the program causes the television to tune to a channel corresponding to the program.
